(19) United States
(12) Patent Application Publication
(10) Pub. No.: US 2007/0219926 A1
(43) Pub. Date: Sep. 20, 2007

(54) Secure method and system of identity authentication

(76) Inventor: Stanley Korn, Arlington, VA (US)

Correspondence Address: MAXVALUEIP CONSULTING, 11204 ALBERMYRTLE ROAD, POTOMAC, MD, 20854, US

(21) Appl. No.: 11/550,412

(22) Filed: Oct. 18, 2006

(51) Int. Cl. H04L 9/00

(52) U.S. Cl. 705/67

(57) ABSTRACT

This application describes a system and method that enables the two parties to a transaction to authenticate each other's identity in such a manner as to be secure against all known threats. We examined various situations to show that the system withstands various attacks, even the sophisticated ones. It can be applied to various transaction settings, such as for ATM, online, and telephone. It improves the security in many prior systems.

### BACKGROUND OF THE INVENTION

Identity fraud and, in particular, identity theft is a major and growing problem. The present disclosure is a system that enables each party in a transaction to authenticate its identity to the other party in such a way as to preclude the possibility of identity misrepresentation by either party. While this system can be used to provide mutual identity authentication between any two parties, be they individuals, organizations, or devices, the transactions in the embodiment/example described herein are between a customer and a service provider, as this is expected to be the most common application of the present invention. Service providers include, but are not necessarily limited to, merchants, financial institutions, and government agencies.

The identity authentication system that is the subject of this invention is designed to eliminate all of the known vulnerabilities in existing identity authentication systems.

### DESCRIPTION OF THE RELATED ART

Smart Cards. A smart card is essentially a credit card with an embedded computer chip designed to assist in the processing of transactions.

Biometric Identification is the identification of individuals based upon their physiological and behavioral characteristics. Examples include fingerprint identification and retinal scanning.

In order to defeat a biometric identification system, the perpetrator must accomplish two objectives. He must obtain the information content of the biometric scan of the person he wishes to impersonate, and then use that information to construct a device that is able to fool the biometric scanner into misidentifying it as part of the physiology of the person to be impersonated. For a fingerprint (e.g., thumbprint) identification system, the first task is not hard to accomplish, since a person leaves his fingerprints on whatever he touches. Once the perpetrator obtains a thumbprint of the intended victim, he can then have it impressed upon a rubber or plastic membrane worn around his thumb, or perhaps on a magician's false thumb.

An identification system using a retinal scanner is far more secure than one using fingerprints. First, because, unlike fingerprints, one does not leave behind retinal prints, but mainly because of the difficulty, if not the impossibility, of passing off someone else's retinal pattern as one's own. Unlike an iris scanner, a retinal scanner is not fooled by the use of contact lenses. It would require eye surgery and the accompanying risk of damaging one's vision in order to alter one's retinal patterns, an operation that few, if any, would be willing to undergo. Furthermore, randomly altering one's retinal pattern would not be sufficient, as that would just result in that person being unrecognized by the system. To be successful, the identity thief would need to impress the retinal pattern of the intended victim onto his own retina, a feat that is well beyond the ability of current technology to accomplish. An attempt to use an artificial eye to fool the retinal scanner would be easily detectable by anyone observing the process.

While a biometric identification system using a retinal scanner or a device of equivalent security can provide a secure means of identity authentication when biometric scanner is under the observation and control of the identity authenticator during the scanning process, such a biometric identification system is not, by itself, able to provide a secure means of identity authentication for remote (e.g., online or telephone) transactions. To see why, suppose, for example, that someone has attached a retinal scanner to his computer, and offers to authenticate his identity to an online merchant by sending that merchant a digitized copy of his retinal scan, and suppose that the merchant accepts that offer. If that merchant happens to be dishonest, there's nothing to prevent him from passing off the customer's digitized retinal scan as his own to a third party. The present invention overcomes this limitation inherent in biometric identification systems, and provides a secure means of identity authentication for remote as well as proximate transactions.

Two-Key Cryptography. A cryptographic system in which the encryption key differs from the decryption key. Depending on the application, one of the keys is made public while the other key remains private.

Public-Key Encryption is an application of two-key cryptography in which the encryption key is public while the decryption key is private. It can be used to enable secure communication between two parties. To do so, each party encrypts its message with the public encryption key of the other party before transmitting it to the latter. Public key encryption has an advantage over a single key cryptographic system because, unlike the latter, it does not require prior contact between the sender and the receiver to exchange keys.

Digital Signature. A method to verify that a document or other information was produced or approved by a particular person. To produce a digital signature for a document, a hash code is generated for that document. The hash code is then encrypted with the private encryption key of the person digitally signing the document, and that encrypted hash code is then appended to the document. To verify that the document was digitally signed by the person in question, the verifier decrypts the encrypted hash code using the signer's public decryption key. The verifier then generates the hash code for the document and compares it to the decrypted hash code; if the two match each other, then the digital signature is authenticated.

DNA Identification makes use of the fact that certain regions of human DNA vary from person to person. By analyzing these variable regions of the DNA, a profile can be created of an individual that has an extremely small chance of being identical to another person's DNA profile.

### SUMMARY OF THE INVENTION

This invention makes use of a smart card, herein referred to as a Secure Card, which is issued to those who wish to use what is herein termed the Secure Card system, which is the subject of this present invention. Both first time and repeat applicants (e.g., those who have lost their Secure Cards) have their identities authenticated by DNA profiling. The applicants are issued Secure Cards, which come preprogrammed with the encryption and decryption algorithms for a public key encryption system, and a public encryption/private decryption key pair.

First time applicants are assigned a unique identification number, herein termed their Universal Identification Number (UIN), by which they are identified in what is herein termed the Universal Database, a trusted source which contains all publicly available information associated with the Secure Card system. All applicants submit to a biometric scan, and the digitized biometric scan data along with the applicant's name and UIN are burned into the read-only memory (ROM) of the Secure Card. The applicant's name, UIN, his Secure Card's public encryption key, and his digitized DNA profile are stored in the Universal Database.

To use his Secure Card to authenticate an online or telephone transaction, the user must acquire a Secure Card Interface Device (SCID), which is the sole means by which the Secure Card interacts with the outside world. Each SCID has its own UIN and, similar to the Secure Card, has a microprocessor on which is programmed the algorithms for the public key encryption system, along with a key set. The SCID's UIN, public encryption key, and the UIN of the user to whom it is registered are listed in the Universal Database.

To use his Secure Card for an online transaction (for example), the user's SCID must be connected to his computer. The user begins by inserting his Secure Card into the slot provided in the SCID. The Secure Card then checks to see if the SCID is on its list of trusted devices, or registered to a trusted person. If so, the Secure Card authenticates the SCID's identity by issuing it a decryption test, which consists of sending the SCID a random text string encrypted with the SCID's public encryption key; the SCID passes the test if it is able to decrypt that text. Once the Secure Card has authenticated the SCID, it releases the confirmation code, preset by the user, to let the latter know that it's safe to trust the SCID with his sensitive information.

Having authenticated the SCID, the Secure Card next authenticates the user by having the latter submit to a biometric scan; if his biometric scan data matches the version stored in his Secure Card, his identity is verified. For added security, and as a defensive measure in the event of a coerced transaction, the user is required to enter one of his personal identification numbers (PINs); entering a distress PIN will enable the user to secretly (to the attacker) notify the police or authorities.

After the user's Secure Card has authenticated the user and his SCID, its next task is to authenticate the service provider with which the user is transacting. It requires that the service provider to be on its (the Secure Card's) list of trusted organizations, and that the person with whose Secure Card it is interacting be a trusted employee of the service provider. It then authenticates the employee's Secure Card by issuing it a decryption test. Likewise, the employee's Secure Card authenticates the user by issuing the latter's Secure Card a decryption test.

For transactions where the customer uses the service provider's SCID, the authentication sequence is slightly different. In this case, the customer's Secure Card first authenticates both the service provider and its SCID by a decryption test, then it authenticates the user by biometric scan and PIN, and finally, the Secure Card of an employee of the service provider authenticates the customer by issuing the latter's Secure Card a decryption test.

The main advantage of the Secure Card system is that it is not vulnerable to any of the known security threats. In particular, no information is entered into, resides on, or passes through any computer, the disclosure of which would compromise the security of the system. Thus the Secure System is secure against threats posed by hackers, spyware, and the loss or theft of computer files. Furthermore, no information is exchanged in any transaction authenticated with the Secure Card system that would enable an eavesdropper or dishonest employee to later impersonate the customer. Because the Secure Card system's identity authentication protocol requires the service provider to authenticate its identity to the customer as well as vice versa, the customer is secure against the threats of phishing and phony websites. The fact that the Secure Card authenticates the identity of the device with which it is interfaced before giving the user approval to submit to a biometric scan and enter his PIN protects the user from being victimized by bogus ATMs and other phony devices. Finally, in the event that the user becomes the victim of a coerced transaction such as being kidnapped and forced to withdraw cash from an ATM, the Secure Card system affords the user, via distress PINs, a means of secretly notifying the police/authorities and taking other defensive actions.

### BRIEF DESCRIPTION OF THE DRAWINGS

FIG. 1 shows the fields for each type of record stored in the Universal Database.

FIG. 2 is a block diagram for online transactions.

FIG. 3 is a flow diagram for online transactions.

FIG. 3a shows the process by which the Secure Card authenticates the identity of the SCID.

FIG. 3b shows the process by which the Secure Card authenticates the user's identity.

FIG. 3c shows the services that can be performed via the main menu and submenu options.

FIG. 3d shows the fields for the records for each type of list stored on the Secure Card.

FIG. 3e shows the process by which the user's Secure Card authenticates the identity of the service provider.

FIG. 3f shows the process by which the service provider authenticates the identity of the user.

FIG. 4 is a block diagram for operator-assisted telephone transactions

FIG. 5 is a block diagram for transactions using a service provider's SCID.

FIG. 6 is a flow diagram for transactions using a service provider's SCID.

FIG. 6a shows the process by which the customer's Secure Card authenticates the identity of the service provider and its SCID.

FIG. 6b shows the process by which the customer's Secure Card authenticates the identity of the customer.

FIG. 6c shows the process by which the server operator's Secure Card authenticates the identity of the customer.

FIG. 7 is a block diagram showing the worst case security threat posed by a bogus ATM.

### DETAILED DESCRIPTION OF THE PREFERRED EMBODIMENTS

This invention makes use of a smart card, herein referred to as a Secure Card, whose functions and capabilities are to be described. The identity authentication system that is the subject of this invention will be herein referred to as the Secure Card system.

Each Secure Card comes from the factory preprogrammed with the encryption and decryption algorithm for a two key cryptographic system, as well as a private decryption key. The private decryption key is randomly generated for each Secure Card, and recorded nowhere else. The corresponding public encryption key is also recorded on the Secure Card.

To use the Secure Card system, an individual visits the branch office of the corporation or government agency administering the Secure Card system. There, he fills out an application and has a biometric scan taken. In the preferred embodiment of this invention, a retinal scanner or some other biometric scanner having an at least equal degree of security is used.

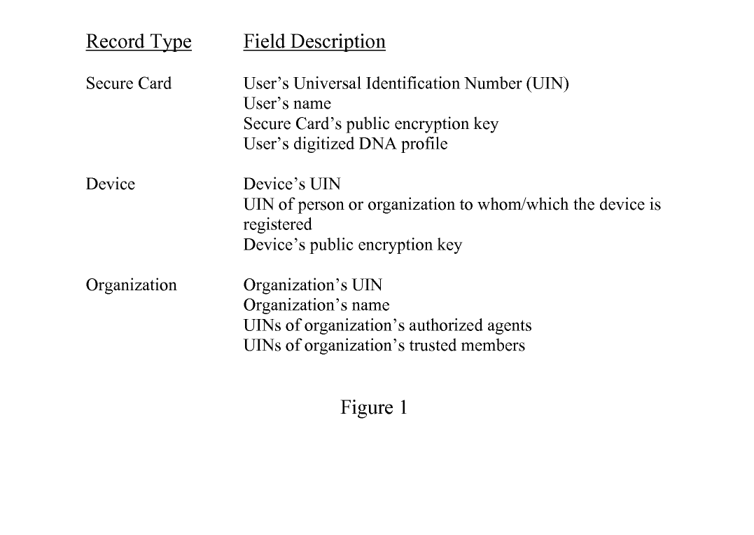

In order to use the Secure Card system, each individual needs to be assigned a unique identifying number, herein referred to as his Universal Identification Number (UIN); a person's Social Security Number could be used for this purpose. The applicant's UIN, name, and a digitized copy of his biometric scan are then burned into the read-only memory (ROM) of the Secure Card that is issued. In addition, the applicant's UIN, name, and his Secure Card's public encryption key is recorded in a database, herein referred to as the Universal Database, a trusted source maintained by the corporation or government agency administering the Secure Card system. (The Secure Card will disclose its public encryption key upon request, but is programmed to never reveal its private decryption key.) See FIG. 1 for a description of the records stored in the Universal Database.

As an added security measure, a sample of the applicant's DNA is taken, and the applicant's digitized DNA profile is compared with those for all of the other individuals in the Universal Database. If this is the first time that the applicant has applied for a Secure Card, then there should be no DNA match (except, perhaps, if the applicant has an identical twin whose record is already in the Universal Database, in which case a secondary identifier may be used to assure uniqueness). If the applicant had previously applied for a Secure Card, then his DNA sample will match the one he submitted in his previous application, thus authenticating his identity. This DNA matching procedure prevents someone from applying for a Secure Card in someone else's name.

A business or other organization wishing to make use of the Secure Card system is assigned a UIN. The organization's Federal Tax Identification Number, if applicable, may be used as its UIN. The organization's UIN, name, a list of the UINs of the organization's authorized agents, and a list of the organization's trusted members are then recorded on a record entered into the Universal Database. The distinction between an organization's authorized agents and its trusted members is that while members of either group may enter into Secure Card transaction on behalf of the organization, only authorized agents have the authority to make changes to the organization's record in the Universal Database (e.g., to add and delete trusted members to reflect turnover in the organization).

In order to make use of his Secure Card, the user needs to have a Secure Card Interface Device (SCID), which is the means by which the Secure Card communicates with the outside world. When the user purchases or leases a SCID, the SCID's UIN and public encryption key are recorded in the Universal Database along with UIN of the user to whom the device is registered.

In order to describe the function and capabilities of the Secure Card and the SCID, the operation of these as well as the other components of the Secure Card system will be described in the context of the various types of transactions in which they may be involved. These descriptions are designed to illustrate a particular embodiment of the invention, and are not meant to limit in any way the scope of the invention, or the claims made with regard to the latter.

### Online Transactions

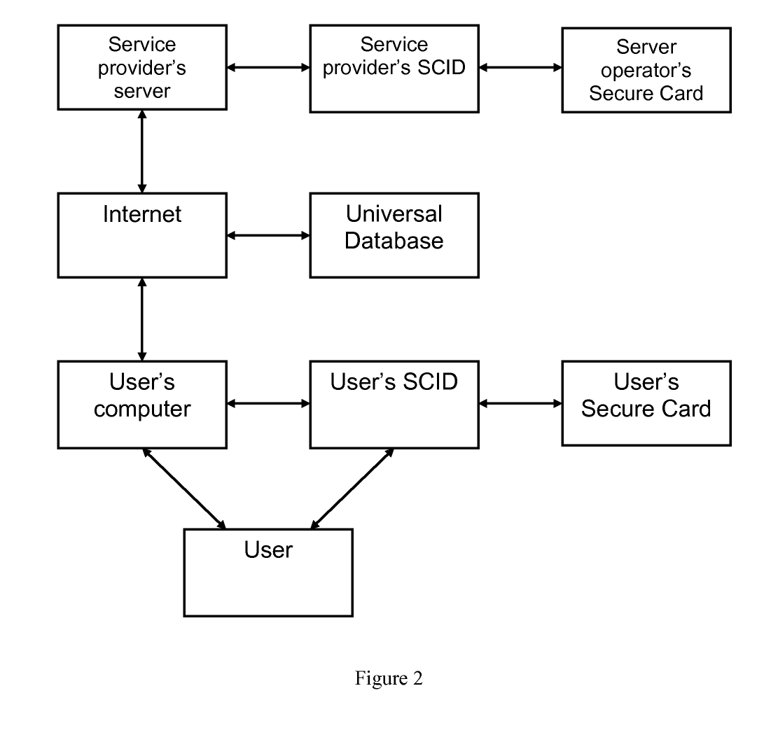

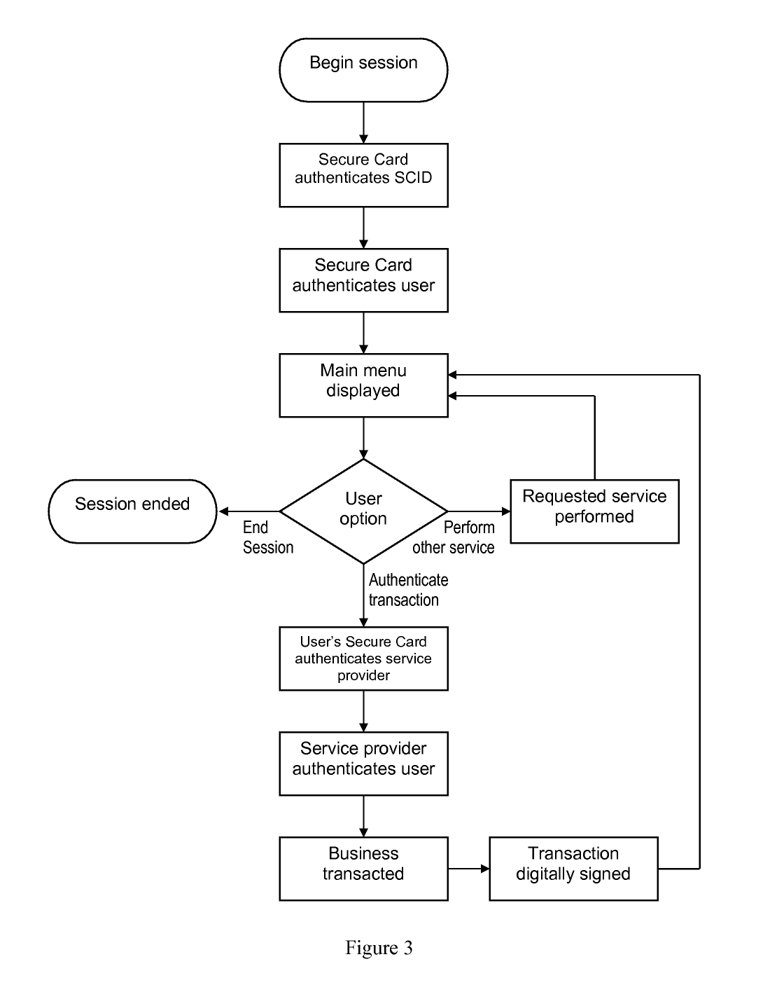

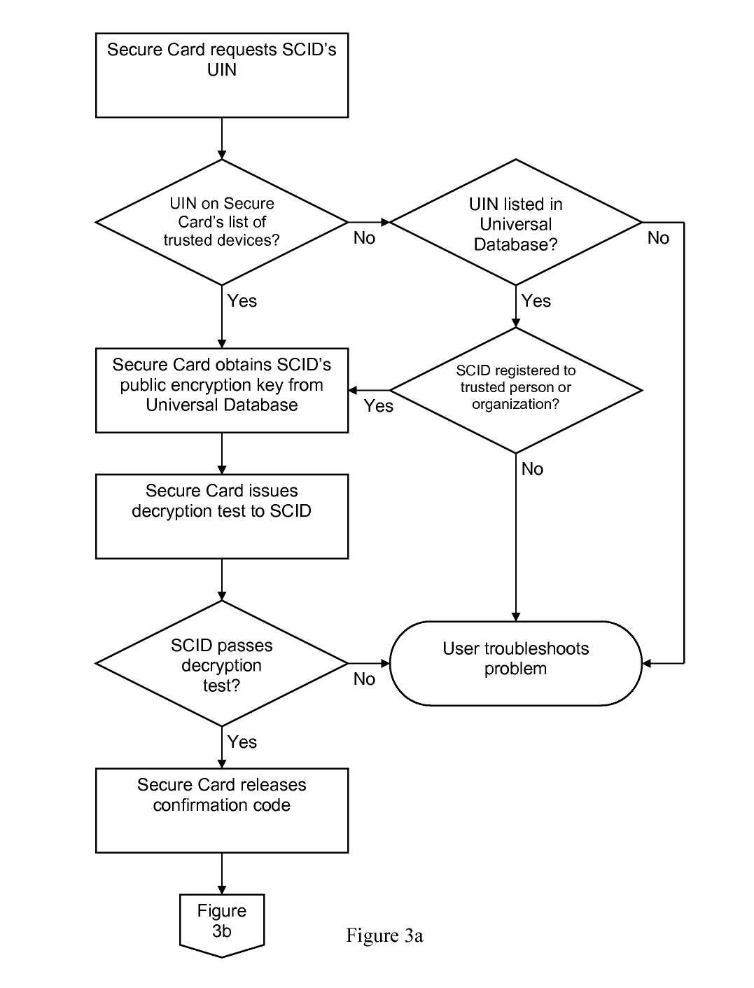

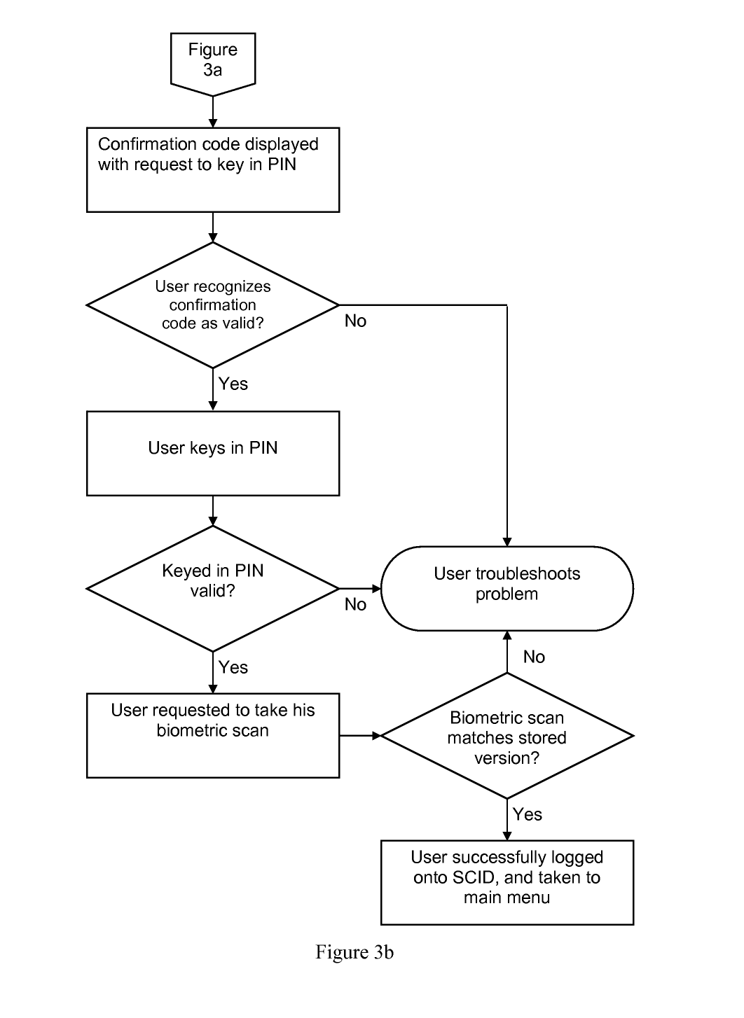

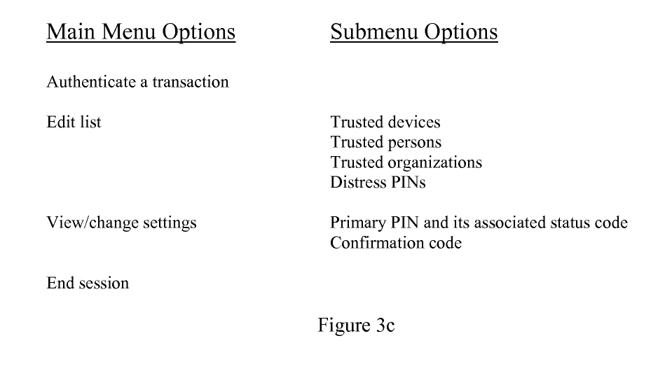

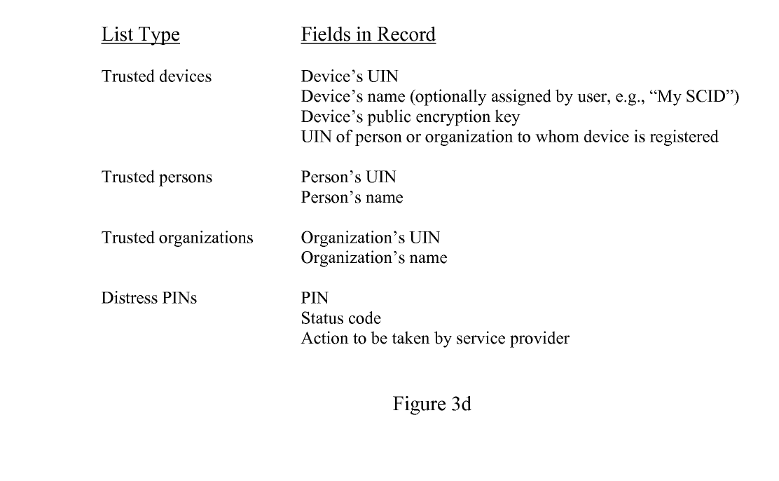

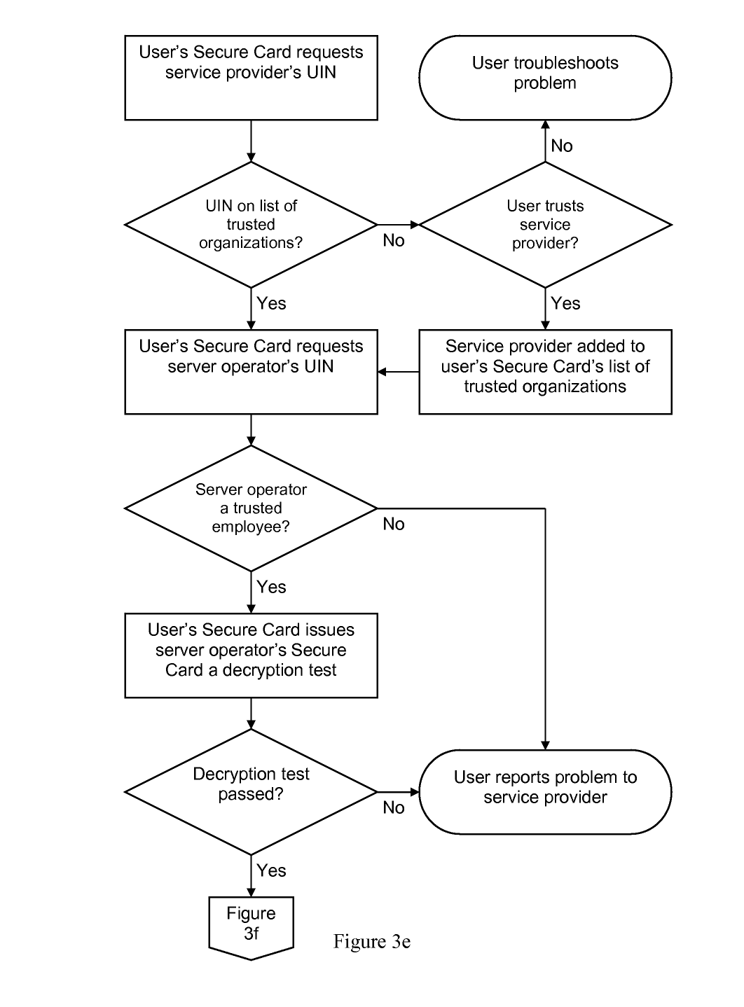

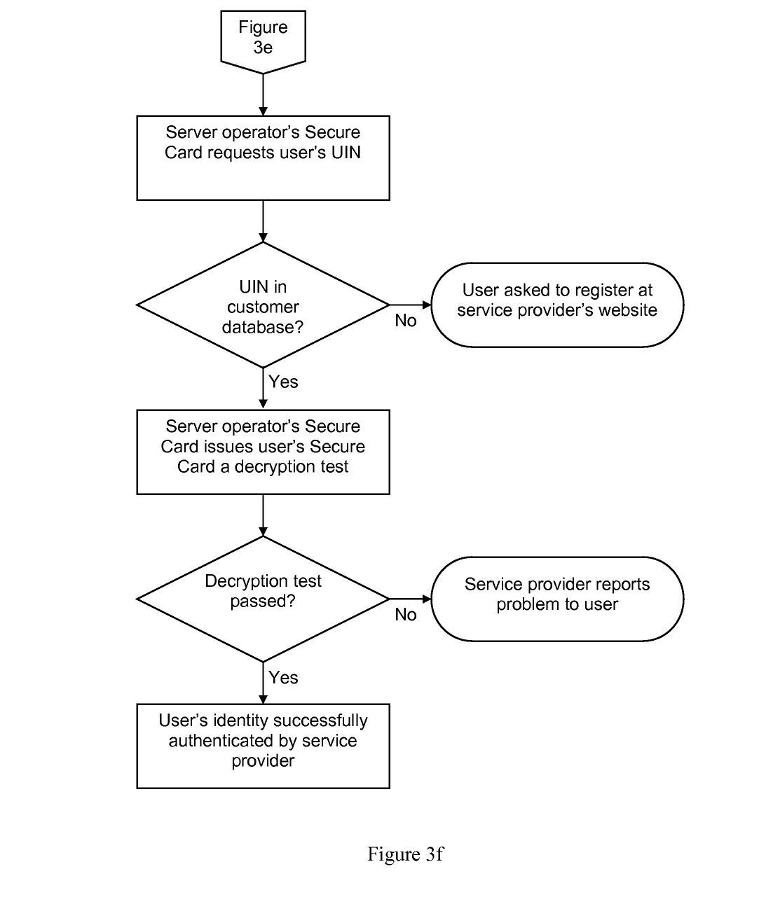

To use his Secure Card for online transactions, the user begins by connecting his SCID to his computer, e.g., via one of his computer's USB ports. (See FIG. 2). He then installs the Secure Card application software that comes with his SCID. When he launches the Secure Card application, the user will be instructed to turn on the SCID and insert his Secure Card in the slot provided in the SCID if he hasn't already done so. The SCID supplies the power for the microcomputer embedded in the Secure Card. At this point, the Secure Card system's identity authentication protocol begins. (See FIG. 3).

The Secure Card begins by asking the SCID for its UIN. (See FIG. 3a). The Secure Card then checks to see if the SCID's UIN is on its list of trusted devices that is stored on the Secure Card's nonvolatile memory; if not (as would be the case if this is the first time that the Secure Card has been used), then the Secure Card attempts to authenticate the SCID by sending a query to the Universal Database. Since the Secure Card has no way of knowing at this point if it is dealing with a bogus SCID designed to trick the user into entering sensitive information, it must take precautions to ensure that its communications with the outside world pass through the SCID unaltered. To this end, the Secure Card forms a string consisting of its own UIN concatenated with the UIN of the SCID (as provided by the latter) and a randomly generated text string, and encrypts the resulting string using the public encryption key of the Universal Database. (All Secure Cards come preloaded with the public encryption key of the Universal Database.) The Secure Card then sends this encrypted string to the SCID, which passes it along to the user's computer, which, in turn, passes the request along to the Universal Database via the Internet. (If, at this point, the user doesn't have an active connection to the Internet, he will be directed to establish one.)

When the Universal Database receives the Secure Card's message, it decrypts it using its private decryption key. If the SCID's UIN is not listed in the Universal Database, that fact will be so indicated in the return message to the Secure Card. If the SCID is registered to a person, that person's UIN, the UINs of any organizations of which he is a trusted member, and the SCID's public encryption key will be included in the return message. If the SCID is registered to an organization, that organization's UIN and the SCID's public encryption key will be included in the return message. The Universal Database includes the Secure Card's random text string in its return message, and encrypts the message using the Secure Card's public encryption key.

When the Secure Card receives its reply back from the Universal Database, it decrypts it using its private decryption key, and checks for the presence of its random text string to authenticate the message. If the SCID is registered to a person, the Secure Card checks to see if that person is on its list of trusted persons, or, failing that, if that person is a trusted member of an organization on its list of trusted organizations. (The user is, by default, on his Secure Card's list of trusted persons.) If the SCID is registered to an organization, the Secure Card checks to see if that organization is on its list of trusted organizations.

If the Secure Card is unable to verify that the UIN provided by the SCID belongs to a trusted device, it reports that fact to the user and ends the session, requiring the user to troubleshoot the problem. Otherwise, the next step is for the Secure Card to verify that the UIN provided by the SCID is the SCID's actual UIN. To this end, the Secure Card issues the SCID a decryption test, which consists of the Secure Card generating a string of random text, encrypting that string using the public encryption key corresponding to the UIN provided by the SCID, and sending that encrypted text to the SCID. To pass the test, the SCID must decrypt the text. If the Secure Card verifies that the text has been successfully decrypted, that establishes that the SCID is the device that it claims to be. If the SCID fails this test, that fact is reported to the user, requiring him to investigate the problem before proceeding further.

Once the Secure Card establishes that the SCID is a trusted device, it releases a confirmation code to the user for the SCID to display on its video screen. (If this is the first use of the Secure Card, the confirmation code will be at its factory setting.) To prevent possible compromise by spyware that might be residing on the user's computer, all sensitive information that is exchanged between the Secure Card and the user is communicated via the SCID, never through the user's computer, and then only after the user sees the confirmation code that lets him know that the SCID can be trusted. (Like the microprocessor embedded it the Secure Card, the microprocessor in the SCID cannot be programmed by outside instructions, and thus is not susceptible to spyware.)

If the identity of the SCID was authenticated by reference to the Universal Database, the user is given the option of having the Secure Card add the SCID to its list of trusted devices. Such a listing includes the SCID's name (which the user is asked to create), its UIN, and its public encryption key.

Now that the Secure Card has authenticated the identity of the SCID, the next step is for the Secure Card to authenticate the identity of the user. (See FIG. 2b.) The Secure Card begins by asking the user to enter his personal identification number (PIN) via the number pad built into the SCID. (The PIN will be at its factory setting if this is the first use of the Secure Card.) Assuming that the user enters the correct PIN, he is then asked to submit to a biometric scan using the biometric scanner (e.g., retinal scanner) built into or attached to the SCID. If the user's biometric scan matches the copy stored in the Secure Card, the user's identity is authenticated. (A failure to authenticate the user's identity will terminate the session.)

At this point in the process, where the Secure Card has authenticated the identities of both the SCID and the user, the user will be said to be logged onto the SCID with his Secure Card. The user is then presented with a menu of options (the main menu). The options include identity authentication for an online transaction, performing other services, or ending the session.

FIG. 3c shows the services that can be performed via the main menu and submenu options. The user has the option of editing the various lists stored on the Secure Card. The lists containing the trusted devices, persons, and organizations are used for identity authentication as described herein; the record description for these files is shown in FIG. 3d. (To conserve memory space on the Secure Card, the lists of trusted entities that are accessed online exclusively via the user's computer may be stored in files on the latter.)

In addition to the primary PIN with which the user logs onto the SCID under normal circumstances, the user may create one or more distress PINs to be used in the event that the user is forced by an attacker to engage in a Secure Card transaction. Each PIN, including the primary, has an associated status code, which is transmitted to the service provider during a transaction with the latter. To make effective use of the distress PINs, the user must arrange in advance with the service providers to have them take specified action (which will generally include notifying the authorities) when receiving the status code associated with a distress PIN. If the user has logged on with a distress PIN, the display of the distress PIN list is suppressed, making it appear to the attacker as if the user had not bothered to create any distress PINs; likewise, the “primary PIN” shown under the “View/change settings” option is actually the distress PIN with which the user logged on. Examples of the use of distress PINs are given under the threats of home invaders and kidnappers described below.

In order to use the Secure Card for identity authentication for an online transaction, the user must be first logged onto the Internet. If used in conjunction with online banking, the authentication procedure described herein will replace the existing procedure by which the user logs onto his online bank account. If used to authenticate an online purchase, the procedure will begin when the user is asked to select a method of payment, to which he responds by selecting Secure Card.

The online service provider's side of the transaction will usually be handled by a server (computer) to enable fully automated processing of the transaction. The server operator logs onto the SCID connected to the server at the beginning of his shift, leaves his Secure Card in the SCID during his shift, and removes his Secure Card when he logs off at the end of his shift.

The online authentication procedure begins with the user's Secure Card requesting the service provider to provide its UIN. If that UIN is not in the Secure Card's list of trusted organizations, the user will be alerted to that fact, shown the service provider's UIN, and asked if he trusts that organization; if so, the user is given the opportunity to add that organization to the list of trusted organizations, and the procedure continues.

Assuming that the organization is trusted, the Secure Card next asks the service provider for the server operator's UIN, and checks to see if this UIN is listed in the Universal Database as belonging to a trusted person of the service provider's organization. If so, then the user's Secure Card retrieves from the Universal Database the public decryption key of the server operator's secure card and issues a decryption test to the latter. If the server operator's secure card passes this decryption test, then the identity of the service provider is authenticated. (A failure to authenticate at this or any other point in the procedure terminates the process, requiring the user to troubleshoot the problem.)

The process by which the service provider authenticates the customer is similar to the procedure just described by which the customer authenticates the service provider, with the obvious difference that the roles are reversed. If the user is not currently in the service provider's customer database, the user will be asked to fill out an online registration form, allowing the service provider an opportunity to check the credentials of the prospective customer; a decryption test issued to the latter's Secure Card will verify the he is who he says he is.

After the customer and service provider have authenticated their identities to each other, they are ready to transact business. If the transaction involves a purchase, the service provider's account is credited with and the customer's account is debited by the amount of the purchase, as is done with a conventional credit card purchase (prior art).

After the business has been transacted, the service provider presents the customer with a screen specifying the time, date, and nature of the transaction, giving the customer an opportunity to confirm or cancel the transaction. If the customer confirms the transaction, then he and the service provider each get a copy of the transaction digitally signed by both parties using the private keys of the customer's and server operator's Secure Cards.

After the online transaction is completed, the user is brought back to the main menu, where he may choose to begin another online transaction, perform another activity, or end the session.

### Threat Assessment

In this section, the threats to the security of an identity authentication system will be considered, and the ability of the Secure Card system to withstand these threats will be examined.

Eavesdropping. The Secure Card system uses a decryption test (described previously) as the means by which the two parties to a transaction authenticate each other's identity. While one who is eavesdropping on the transaction may capture the encrypted text and the corresponding plaintext used for the decryption test, that information will not enable the eavesdropper to later impersonate either party to the transaction by virtue of the fact that the text used for the decryption test is randomly generated for each decryption test.

Hackers, Spyware, and the Theft of Computer Files. Any information entered into, residing on, or passing through any computer is potentially vulnerable to these threats. The Secure Card system uses no information on any computer the disclosure of which would compromise the security of the system, so it is impervious to these threats.

Phishing and Phony Websites. In a typical instance, the phisher sends emails to his intended victims, informing them that they need to update their account information, and conveniently providing them with a link to what appears to be their bank's website, but is in actuality a phony website designed to capture sensitive information from the unwary. The Secure Card system foils such schemes by virtue of the fact that the phony website would be unable to pass the decryption test necessary to authenticate its identity to the user.

Lost or Stolen Secure Cards. An unauthorized person would be unable to use someone else's Secure Card because his biometric scan would not match the one stored on the Secure Card, in addition to the fact that he wouldn't know the rightful user's PIN. When the user reports his Secure Card missing, that Secure Card's listing is removed from the Universal Database, which prevents anyone, even the original user, from using that Secure Card. The user will then be issued another Secure Card with a different set of encryption/decryption keys.

Home Invaders. For example, home invaders break into the user's house, hold him and his family hostage, and order him at gunpoint to access his online bank account and transfer the money therein to an account designated by the attackers. As a countermeasure, the user would log onto the SCID with a distress PIN, which would signal the bank to alert the authorities. The distress PINs could also be set up to enable the user to take other defensive action as well, for example, encoding the number of attackers in a designated digit of the distress PIN to facilitate police apprehension of the home invaders. Another possibility is that the bank transaction could be fake as well, in the sense that it shows that the money has been transferred to the attacker's account, but in reality, no money has been moved out of the user's account.

Switched SCID. The threat considered here would occur if attackers were to break into the user's home and surreptitiously replaces his SCID with one rigged to capture his biometric scan and PIN. Such a scheme would not succeed because the bogus SCID would be unable to pass the decryption test issued by the user's Secure Card.

### Telephone Transactions

Except as herein noted, the identity authentication protocol for telephone transactions is similar to that for online transactions.

To use the SCID for telephone transactions, it must be connected to the phone line shared by the user's telephone at the phone jack preferably located in the back of the SCID. The SCID may, but need not be, connected to the user's computer for telephone transactions. If the SCID is not connected to the user's computer, the user can be guided through the identity authentication protocol via voice prompts given through the telephone.

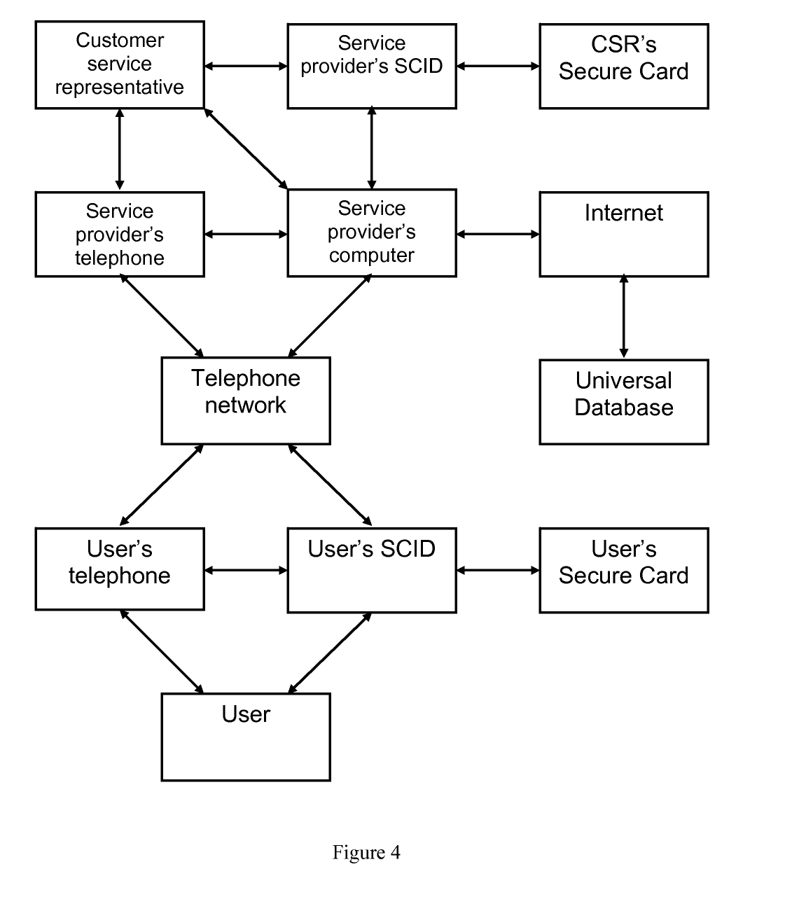

As is the case of online transactions, the user must be logged onto his SCID with his Secure Card in order to authenticate a telephone transaction. How processing is handled at the server provider's end depends upon the type of transaction. For transactions such as automated banking, processing would be handled by a server, as is the case for online transactions. Transactions such as purchasing merchandise from a catalog would require the assistance of a customer service representative (CSR) to take the order. FIG. 4 is a block diagram for such operator-assisted telephone transactions.

In operator-assisted transactions, the customer places his order with the CSR. When the CSR asks the customer how he (the customer) wishes to pay, and the customer specifies Secure Card, the customer and service provider authenticate each other's identity in a manner similar to that done for online transactions. Unless the user's SCID is connected to his computer, which happens to be connected to the Internet, the user's Secure Card will have no direct connection to the Internet, in which case it must go through the service provider's connection to the Internet in order to access the Universal Database, which it needs in order to authenticate the identity of the service provider.

If the user's SCID is not connected to his computer, the digitally signed copy of the transaction can be stored in the SCID's memory, and later transferred to the user's computer, and optionally printed out.

The only possible threat to security not already considered would be a dishonest CSR. As discussed previously, no information provided by the customer during the transaction or residing on any of the service provider's computers would be capable of compromising the security of the Secure Card system. Furthermore, since both the customer and service provider receive digitally signed copies of the transaction, any irregularities in the transaction would be easily traced back to the CSR involved. Thus the Secure Card system is secure against the threat of dishonest employees.

### Transactions Using a Service Provider's SCID

Transactions of this type typically involve purchases in the store or other facility of a merchant or service provider. Banking transactions made at an automated teller machine (ATM) would also fall in this category; however, because of the special security challenges posed by ATMs, security threats involving ATMs are considered in a separate section.

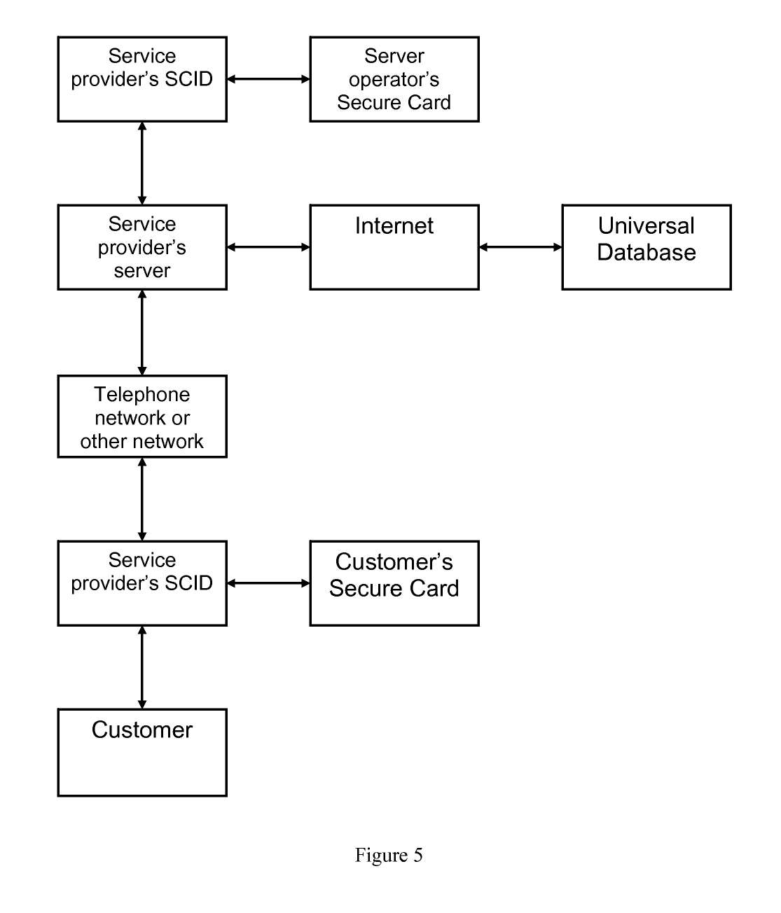

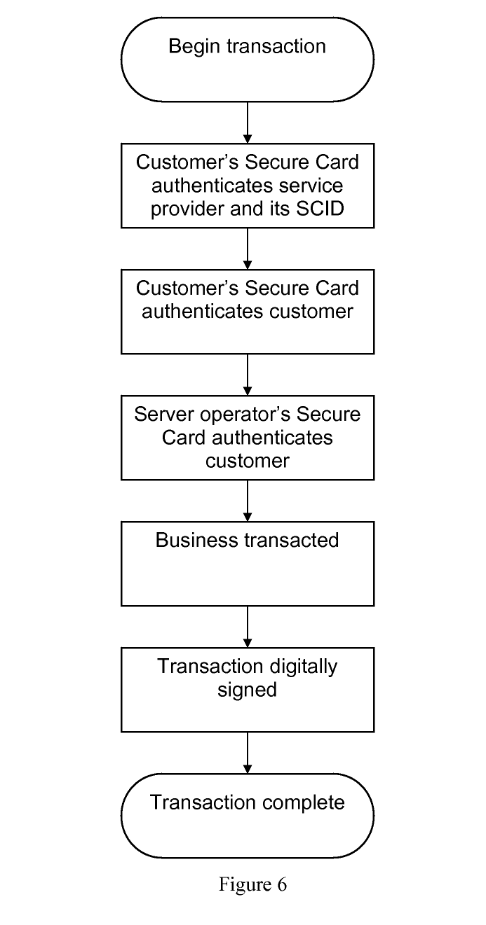

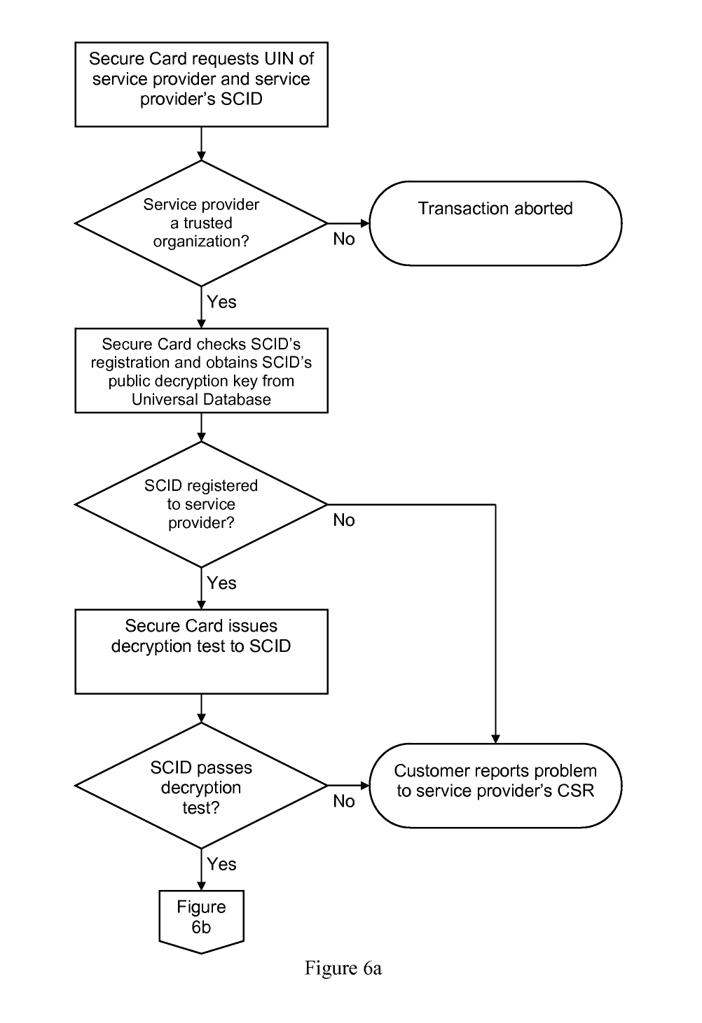

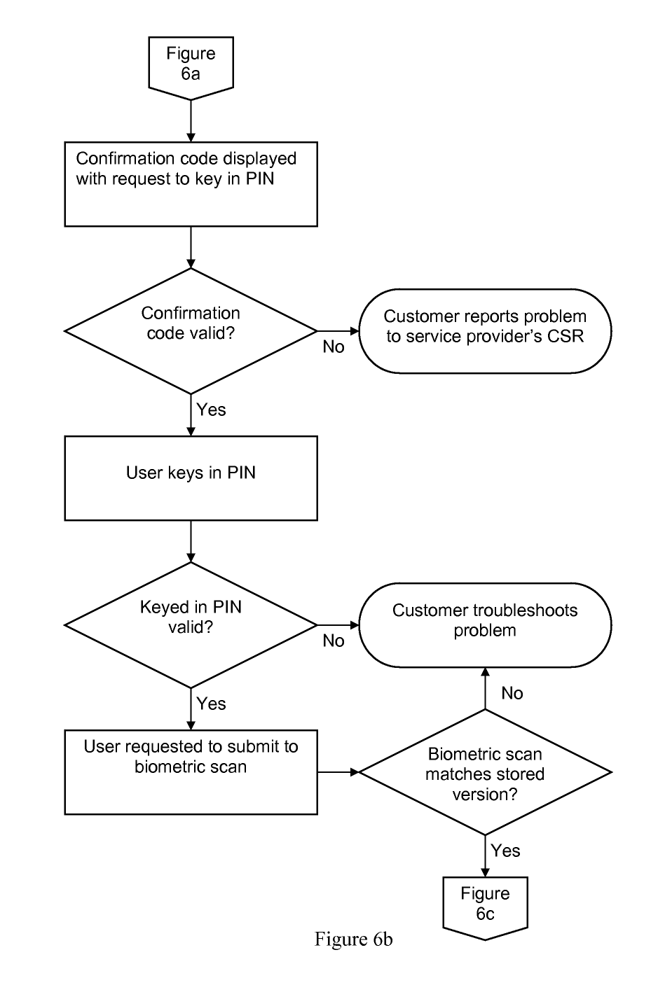

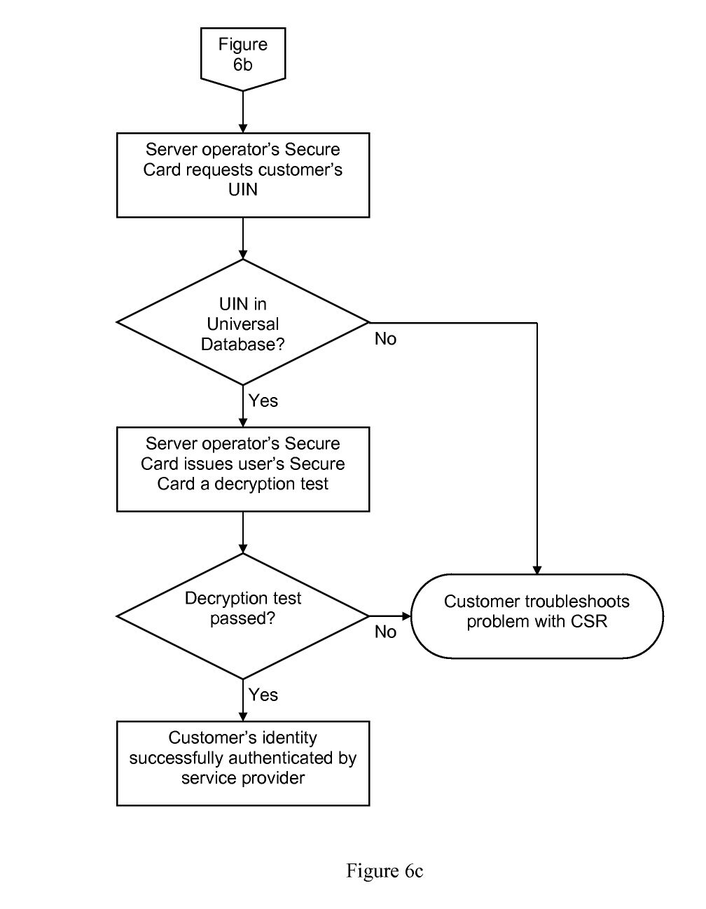

FIG. 5 is a block diagram for transactions using a service provider's SCID, while FIG. 6 is a flow diagram for this type of transaction.

In order for a customer to engage in a transaction using a service provider's SCID, the service provider to which the SCID is registered must be on the customer's Secure Card's list of trusted organizations.

The customer initiates the transaction by inserting his Secure Card into the service provider's SCID. The Secure Card begins by requesting the UIN of the service provider, as well as the UIN of the service provider's SCID with which it is interfaced. (See FIG. 6a.) If the service provider is not on the Secure Card's list of trusted organizations, the customer is so notified and the transaction aborted; otherwise, the Secure Card sends, via the service provider, a query to the Universal Database to confirm that that SCID is registered to the service provider, and to obtain the public encryption key of the SCID. If the SCID is not registered to the service provider, a message to that effect is displayed, and the customer reports the problem to one of the service provider's CSRs for troubleshooting; otherwise, the Secure Card issues the SCID decryption test. If the SCID fails the test, the customer reports the problem to the CSR. If the SCID passes the test, its identity is authenticated, in which case the Secure Card releases the confirmation code to be displayed to the customer.

Assuming that the Secure Card has authenticated the identity of the SCID, the next step is for the Secure Card to authenticate the identity of the customer. (See FIG. 6b.) The Secure Card begins by asking the user to enter his PIN. Assuming that the user enters the correct PIN, he is then asked to submit to a biometric scan. If the customer's biometric scan matches the copy stored in the Secure Card, the customer's identity is authenticated. A failure to authenticate the customer's identity will terminate the transaction, requiring the customer and CSR to resolve the problem.

The next step is for the service provider to authenticate the identity of the customer. This process is conducted by the Secure Card of the operator of the service provider's server. (See FIG. 6c.) The operator's Secure Card begins by asking the customer's Secure Card for the customer's UIN, which it looks up in the Universal Database to obtain the public encryption key of the customer's Secure Card. Using that public encryption key, the operator's Secure Card then issues a decryption test the customer's Secure Card. If the test is passed, then the customer's identity is authenticated and the transaction can proceed; otherwise, the transaction is aborted, requiring the customer to resolve the problem in consultation with the CSR.

After the identity authentication portion of the transaction is complete, the business of the transaction can be conducted, which generally includes debiting the customer's account and crediting the service provider's account with the amount of the purchase.

The last step is for a description of the transaction to be digitally signed by both the customer's Secure Card and the server operator's secure card, a copy of which is given to the customer as his sales receipt.

### ATM Transactions

ATMs pose special security challenges by virtue of the fact that they are generally in remote locations, not under observation by bank employees. The ability of the Secure Card system to withstand these security threats will next be examined.

Kidnapping. In a typical case, the kidnapper forces the victim to drive to an ATM and withdraw cash from his bank account. As a defensive measure, the victim would use a distress PIN to enable him to secretly notify the police. Additionally, a distress PIN could be set up to make the bank balance to appear to be artificially low in order to limit the amount of cash withdrawn.

Bogus ATM. This can take the form of a stand-alone machine or a false cover placed on an existing ATM. In either case, the purpose is the same, namely, to trick the customer into revealing sensitive information that can be later used to impersonate him.

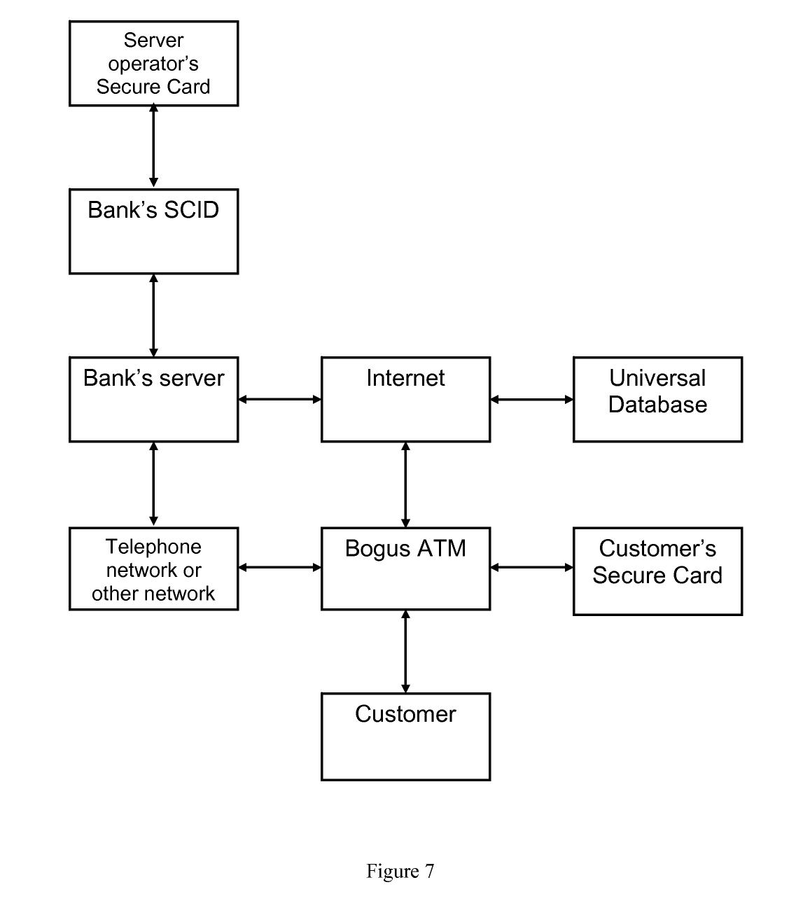

The worst case, from a security standpoint, would be if the perpetrators (there's likely to be more than one for a scheme of this complexity) were able to replace an existing ATM with a bogus one, connect that bogus ATM to the existing communication link to the bank, and provide the bogus ATM with an independent (e.g., wireless) connection to the Internet in order to access the Universal Database. This worst case scenario is depicted in FIG. 7.

This so-called man-in-the-middle attack mounted by the bogus ATM is particularly formidable because all communication between the entities involved in the transaction, namely, the customer, the customer's Secure Card, the bank, and the Universal Database must pass through the bogus ATM, which may alter or block such communication at will.

Upon being inserted into the ATM's SCID, the first thing that the Secure Card does is to request the UIN of the bank and the UIN of the SCID. Since the bogus ATM has no way of knowing what organizations other than the bank to which it is connected are on the Secure Card's list of trusted organizations, it must provide the Secure Card with the bank's UIN in order to prevent the Secure Card from immediately terminating the transaction.

Once the Secure Card has obtained the UINs of the SCID and bank, as provided by the bogus ATM, it sends a request to the Universal Database to check that the SCID is registered to the bank, and, if so, requests that SCID's public encryption key. For security, the request is concatenated with a randomly-generated text string, and the resulting string is encrypted with the public encryption key of the Universal Database. This encrypted message is then sent to the bogus ATM's SCID, with instructions to pass it on to the Universal Database.

Since the bogus ATM lacks the private decryption key of the Universal Database, it is unable to read the Secure Card's message, nor can it alter that message without converting it to gibberish. If the bogus ATM were to replace that message with a message of its own, the substitution would be detected by the Secure Card because the return message from the Universal Database would not contain the random text string. Thus the only viable option for the bogus ATM is to pass the Secure Card's message unaltered on to the Universal Database. Likewise, since the return message from the Universal Database is encrypted with the Secure Card's public encryption key, and the bogus ATM lacks the Secure Card's private decryption key, the bogus ATM must pass that message along to the Secure Card unaltered.

If the SCID's UIN, as provided by the bogus ATM, is not on the list of devices registered to the bank, then this fact will be revealed in the Universal Database's return message to the Secure Card. If, on the other hand, that UIN belongs to a device registered to the bank, then the bogus ATM would lack the private decryption key of that device, and would thus fail the decryption test issued by the Secure Card. In either case, the Secure Card would have failed to authenticate the bogus ATM, and would thus not release the confirmation code. Since the customer knows (or, more precisely, should know) not to key in his PIN or submit to a biometric scan until he sees his confirmation code, the bogus ATM would have failed in its attempt to gain this sensitive information from the customer.

Human Error. Since people do make mistakes, it is important to assess the vulnerability of any system to failure, especially catastrophic failure, due to or in the presence of human error. It has previously been shown that the Secure Card system is able to withstand the threat of a bogus ATM provided the customer knows not to trust an ATM with his sensitive information until he sees his confirmation code displayed. In order to allow for the possibility of human error, the possible consequences of a customer being tricked into keying in his PIN and submitting to a biometric scan without seeing his confirmation code will next be considered.

Assuming that the bogus ATM has obtained the PIN and biometric scan from an unwary customer, the perpetrators would still need that customer's Secure Card in order to impersonate him. The bogus ATM could be set to capture the Secure Cards of such unwary customers.

Once the perpetrators had possession of the PIN, biometric scan data, and Secure Card of a customer, their next step would be to construct an artificial body part—an artificial eye, in the case of a retinal scanner—that would replicate the biometric scan pattern of the customer's body part. Even assuming that the perpetrators succeeded in the rather formidable task of constructing an artificial eye (say) capable of fooling the retinal scanner of a SCID, its use would be limited to remote locations because its use would be easily detectable by someone observing the transaction. A further limitation is that the Secure Card could only be used with a SCID that is on the Secure Card's list of trusted devices, or is registered to a trusted person or organization. Without being able to log onto a SCID, the perpetrators would have no way of knowing the contents of the Secure Card's trusted lists, although it can be presumed that the bank connected to the bogus ATM at which the customer made the transaction would be on the list of trusted organizations. Thus the only locations at which the perpetrators could use the customer's secure card would be ATMs of the customer's bank to which the bogus ATM was connected.

While it is possible that given sufficient time and resources the perpetrators could construct an artificial eye capable of fooling a retinal scanner, the perpetrators wouldn't have that time because when the customer reports that his Secure Card had been snatched, the Secure Card's listing would be immediately removed from the Universal Database, rendering the Secure Card unusable. Furthermore, even those customers whose Secure Cards hadn't been taken by the bogus ATM would notice a problem when that ATM failed to display their confirmation code, and report that problem to the bank. The bank would then send a team of troubleshooters to investigate the problem. When the troubleshooters discovered that the ATM was bogus, they would either shut it down immediately or keep it under surveillance in order to catch the perpetrators.

### Application to Countering Terrorism

In the process of authenticating each other's identities with the Secure Card system, the parties to a transaction automatically generate queries to the Universal Database. These queries contain the UINs of all persons, devices, and organizations involved in the transaction. Since each of these entities has a unique UIN, law enforcement agents could (with proper authorization, of course) use these transaction records to track the whereabouts and activities of persons of interest (e.g., criminal or terrorism suspects), and ascertain the persons and organizations with whom they transact business. Watch lists could be set up such that the authorities would be alerted when a person on those lists engages in specified types of transactions, for example, booking tickets on a commercial airline. Additionally, the Secure Card system constitutes a reliable method of verifying the identity of a person, and determining if he is in this country legally.

Any variation of the teaching above is also meant to be protected by this patent disclosure.

What I claim as my invention is:

1. A system for transaction between multiple parties, said system comprising:
a database;
a communication means;
a secure card; and
a secure card interface device,
wherein a first entity transacts with a second entity through said communication means,
wherein said first entity authenticates the identity of said second entity,
wherein said database is used for said authentication of the identity of said second entity,
wherein said secure card is interfaced with said secure card interface device, and
wherein said second entity is interfaced with said secure card interface device.

2. A system as recited in claim 1, wherein said communication means is the Internet.

3. A system as recited in claim 1, wherein said communication means is a telephone network.

4. A system as recited in claim 1, wherein said communication means is a computer network.

5. A system as recited in claim 1, wherein said system uses a universal identification number.

6. A system as recited in claim 1, wherein said system uses at least one type of biometric information.

7. A system as recited in claim 6, wherein said at least one type of biometric information is a retinal scan.

8. A system as recited in claim 1, wherein said system uses public key encryption.

9. A system as recited in claim 1, wherein said system uses digital signature.

10. A system as recited in claim 1, wherein said system uses a smart card.

11. A system as recited in claim 1, wherein said system uses DNA information.

12. A system as recited in claim 1, wherein said system uses a personal identification number.

13. A system as recited in claim 1, wherein said system uses a list of trusted organizations.

14. A system as recited in claim 1, wherein said system is used in an ATM environment.

15. A system as recited in claim 1, wherein said system is interfaced with a customer service representative.

16. A system as recited in claim 1, wherein said system is used for counterterrorism.

17. A system as recited in claim 1, wherein a victim of a coerced transaction is enabled to take defensive actions through said system.

18. A system as recited in claim 17, wherein said defensive actions comprising secretly notifying the police.

19. A system as recited in claim 17, wherein said defensive actions comprising specifying the number of attackers.

20. A system as recited in claim 17, wherein said defensive actions comprising making an account balance appear to be artificially low.
